(19) United States
(12) Patent Application Publication
(10) Pub. No.: US 2004/0239609 A1
(43) Pub. Date: Dec. 2, 2004

(54) Liquid crystal display, method and apparatus for driving the same

(76) Inventors: Chang-Hun Lee, Yongin-si (KR); Hak-Sun Chang, Seoul (KR)

Correspondence Address: GRAY CARY WARE & FREIDENRICH LLP, 2000 UNIVERSITY AVENUE, E. PALO ALTO, CA, 94303-2248, US

(21) Appl. No.: 10/697,471

(22) Filed: Oct. 29, 2003

(30) Foreign Application Priority Data
May 26, 2003 (KR) 2003-33293

(51) Int. Cl. G09G 3/36

(52) U.S. Cl. 345/100

(57) ABSTRACT

In an LCD operated in an OCB mode, method and apparatus for driving the LCD, responsive to a power source, a timing controller provides a control signal to a switching device so as to apply a bias voltage to an LCD panel during a predetermined first time. After the predetermined first time passes, the timing controller provides a control signal to the switching device so as to apply a common voltage to the common electrode. Also, when a data signal is not input, the timing controller provides the control signal to the switching device such that the bias voltage is applied to the common electrode. Accordingly, although the data signal is not inputted, the LCD may maintain a liquid crystal in a bend alignment state while an image is displayed through the LCD panel.

### CROSS-REFERENCE TO RELATED APPLICATION

This application relies for priority upon Korean Patent Application No. 2003-33293 filed on May 26, 2003, the contents of which are herein incorporated by reference in its entirety.

### BACKGROUND OF THE INVENTION

1. Field of the Invention

The present invention relates to a liquid crystal display and a method and an apparatus for driving the same, and more particularly to a liquid crystal display capable of maintaining a bend alignment state of a liquid crystal display operated in an OCB (Optical Compensated Briefringence) mode, and a method and an apparatus for driving the same.

2. Description of the Related Art

An LCD (Liquid Crystal Display) having various characteristics, for example, such as a small size, low power consumption, a high resolution, etc., is widely applied to electronic instruments, for example, such as a notebook computer, a monitor, a mobile communication system and so on. In accordance with the LCD as a scale-up, recently, the LCD may be applied to a television set in broad.

The LCD, generally, has a drawback such that its contrast and hue are changed due to a position of a viewer who views a screen thereof. In order to overcome the drawback, various methods have been proposed.

For example, when a prism sheet is attached on a light guide plate, the light guide plate may improve linearity of light emitted from a backlight assembly and incident thereon, thereby improving brightness of about 30% in a vertical direction and a visual angle of the light. Also, an IPS (In Plane Switching) mode LCD having the visual angle, which is substantially equal to that of a CRT (Cathode Ray Tube), has been developed, but the IPS mode LCD has a small opening ratio.

Furthermore, in order to improve the visual angle of the LCD, various methods, for example, an OCB (Optical Compensated Briefringence) method, a PDLC (Polymer Dispersed Liquid Crystal) method, a DHF (Deformed Helix Ferroelectric) method, etc., have been developed. Particularly, in an LCD adopting the OCB method, the LCD may have a superior response speed and a wide visual angle.

FIG. 1 is a schematic view illustrating a conventional OCB mode. FIGS. 2A and 2B are schematic views illustrating on/off cycle of the OCB mode.

Referring to FIG. 1, an initial alignment state of a liquid crystal interposed between a lower electrode (or an array substrate) and an upper electrode (or a color filter substrate) is maintained in a homogenous alignment state (Hs). When a predetermined voltage is applied to the lower and upper electrodes, the homogenous alignment state of the liquid crystal is successively changed into a transient splay alignment state (Ts), an asymmetric splay alignment state (As) and a bend alignment state (Bs). The liquid crystal changed into the bend alignment state (Bs) is operated in the OCB mode.

As shown in FIG. 1, the liquid crystal in the OCD mode, generally, has a pre-tilt angle from about 5 to about 20 degrees and a thickness from about 4 to about 7 micrometers at an area adjacent to lower and upper alignment layers. The lower and upper alignment layers are rubbed in the same direction of each other.

The liquid crystal disposed at a center portion of a liquid crystal layer is aligned such that the liquid crystal has a bilateral symmetry. The liquid crystal maintains a tilt angle of about zero degree with respect to a voltage smaller than a specific voltage and a tilt angle of about 90 degrees with respect to a voltage greater than the specific voltage. When a voltage greater than the specific voltage is applied to the liquid crystal layer, so that the liquid crystal disposed at the center portion of the liquid crystal layer has the tilt angle of about 90 degrees. Then, a change of the voltage applied to the liquid crystal layer is carried out so as to tilt the liquid crystal disposed at a remaining portion except the center portion. In this case, a polarizing angle of the light passing through the liquid crystal layer may be adjusted.

In order to align the liquid crystal disposed at the center portion of the liquid crystal layer to have the tilt angle from about 0 degree to about 90 degrees, a predetermined time is needed. However, the liquid crystal has the superior response speed of about 10 microseconds and it does not have a back-flow with respect to a voltage variation.

Referring to FIGS. 2A and 2B, in an ON-state of the OCB mode, a first time needed to change the alignment state of the liquid crystal from the “Ts” state into the “As” state is faster than a second time needed to change the alignment state of the liquid crystal from the “Ts” state into the “Bs” state, and a third time needed to change the alignment state of the liquid crystal from the “As” state into the “Bs” state is slower than the second time. Also, in an OFF-state of the OCB mode, a first time needed to change the alignment state of the liquid crystal from the “Bs” state into the “Hs” state is relatively slow, but a second time needed to change alignment state of the liquid crystal from the “Ts” state into the “Hs” state and a third time needed to change the alignment state of the liquid crystal from the “As” state into the “Hs” state are relatively fast.

As described above, a predetermined time is needed to change the alignment state of the liquid crystal into the “Bs” state so as to operate the liquid crystal in the OCB mode. Thus, in order to entirely induce the bend alignment transition of the LCD panel, a high level voltage is applied to the electronic instruments, for example, such as the monitor and television set, when the electronic instruments are initially operated.

In a conventional monitor turned on, an OSD (On Screen Display) screen is displayed on a screen of the monitor when a data signal is not inputted. Particularly, in case that a cable for supplying an image signal and a timing signal to the monitor and for electrically interconnecting between the monitor and a computer main body is separated from the monitor or computer main body, the OSD screen is displayed on the screen of the monitor so as to alarm that the data signal is not inputted.

In case that the monitor employs an OCB mode LCD and the cable is separated from the monitor or computer main body, a voltage smaller than a critical voltage for inducing a normal bend alignment state of the liquid crystal is applied to the monitor, thereby breaking down the bend alignment state of the liquid crystal. Thus, although the cable is re-interconnected between the monitor and computer main body, an abnormal image may be continuously displayed on the monitor.

### BRIEF SUMMARY OF THE INVENTION

The present invention provides an LCD capable of maintaining a bend alignment state of a liquid crystal display operated in an OCB mode.

The present invention provides a driving method suitable for driving the above LCD.

The present invention provides a driving apparatus suitable for driving the above LCD.

In one aspect of the invention, an LCD includes an LCD panel having a first substrate on which a scan line and a data line are formed, a second substrate on which a common electrode is formed and a liquid crystal layer interposed between the first and second substrates, which is operated in an OCB mode. The LCD includes a source driver that supplies an image signal to the data line in response to a first control signal, a scan driver that supplies a scan signal to the scan line in response to a second control signal, a DC-DC converter that generates a bias voltage having a first voltage level, a switching part that receives the bias voltage and a common voltage having a second voltage level lower than the first voltage level and outputs one of the bias voltage and the common voltage in response to a third control signal or a fourth control signal, and a controller.

The controller receives a power signal and an image signal. Responding to the power signal, the controller provides the third control signal to the switching device so as to apply the bias voltage to the common electrode during a predetermined first time. When the first time passes, the controller provides the first and second control signals to the source and scan drivers, respectively, and provides the fourth control signal to the switching device in response to the image signal such that the common voltage is applied to the common electrode. The controller provides the third control signal to the switching device so that the bias voltage is applied to the common electrode while the image signal is not input.

In another aspect of the invention, according to a method of driving an LCD including an LCD panel having a liquid crystal operated in an OCB mode, a liquid crystal driving module having a scan driver, and a source driver, a backlight assembly disposed at a rear portion of the liquid crystal display panel, and a controller. The liquid crystal is transited into a bend alignment state and an image is displayed on the LCD panel in response to a power source. When a data signal is inputted, the image is continuously displayed on the LCD panel. The controller checks whether or not a first time passes when the data signal is not inputted. When the first time passes, an OSD is displayed on the LCD panel so as to represent that the data signal is not inputted and the liquid crystal is transited into the bend alignment state while the OSD is displayed on the LCD panel. When the data signal is inputted, the OSD is not displayed on the LCD panel and the image is continuously displayed on the LCD panel.

In further aspect of the invention, an apparatus for driving an LCD including an LCD panel having an array substrate having a scan line and a data line, a color filter substrate having a common electrode, and a liquid crystal operated in an OCB mode and interposed between the array substrate and color filter substrate, a backlight assembly providing a light to the LCD panel, a source driver supplying an image signal to the data line, a scan driver supplying a scan signal to the scan line, and a controller.

The controller, responsive to a power source, controls a bias voltage to be supplied to the common electrode, which has a voltage level higher than that of a common voltage supplied to the common electrode, so as to improve a transition speed of the liquid crystal layer into a bend alignment state. When the liquid crystal layer is transited into the bend alignment state, the controller controls the common voltage to be supplied to the common electrode so as to display an image using the image signal. Also, when the image signal is not input, the controller controls the bias voltage to be supplied to the common electrode so as to maintain the bend alignment state of the liquid crystal.

Accordingly, in the LCD operated in the OCB mode, although the data signal is not normally input, the bend alignment state of the liquid crystal may be maintained while the image is displayed on the LCD panel.

### BRIEF DESCRIPTION OF THE DRAWINGS

The above and other advantages of the present invention will become readily apparent by reference to the following detailed description when considered in conjunction with the accompanying drawings wherein:

FIG. 1 is a schematic view illustrating a conventional OCB mode;

FIGS. 2A and 2B are schematic views illustrating on/off cycle of the OCB mode;

FIG. 3 is a schematic view showing an LCD according to an exemplary embodiment of the present invention;

FIG. 4 is a timing diagram of respective signals shown in FIG. 3;

FIG. 5 is a waveform of a bias voltage according to an exemplary embodiment of the present invention;

FIG. 6 is a schematic view showing an LCD according to another exemplary embodiment of the present invention; and

FIG. 7 is a schematic view showing an LCD according to another exemplary embodiment of the present invention.

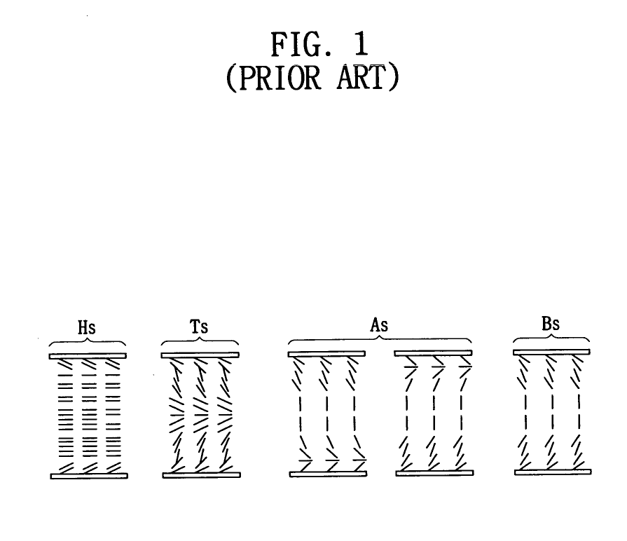

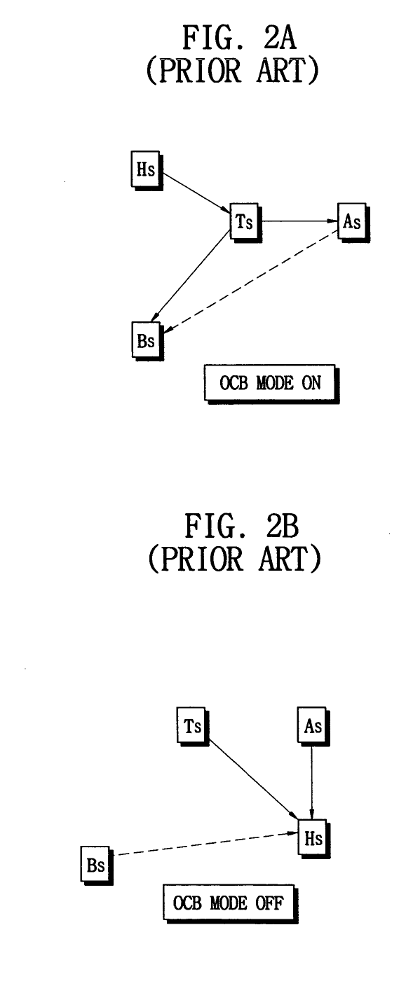

### DESCRIPTION OF THE PREFERRED EMBODIMENT

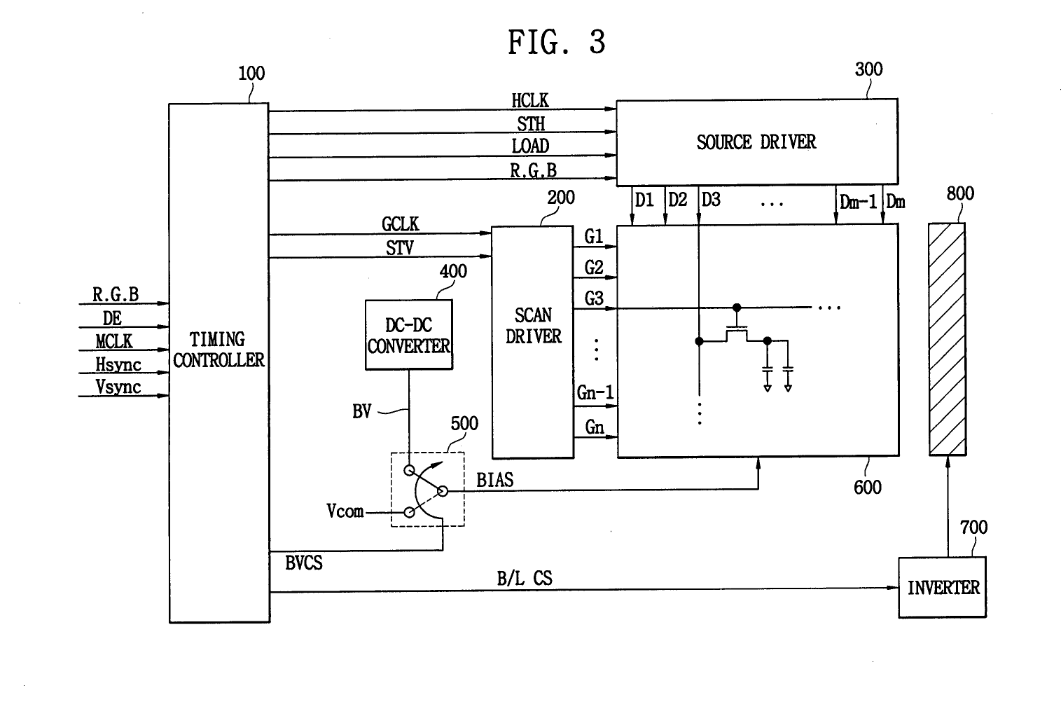

FIG. 3 is a schematic view showing an LCD according to an exemplary embodiment of the present invention.

Referring to FIG. 3, an LCD according to an exemplary embodiment includes a timing controller 100, a scan driver 200, a source driver 300, a DC-DC converter 400, a switching device 500, an LCD panel 600, an inverter 700 and a backlight assembly 800. The backlight assembly 800 is disposed at a rear portion of the LCD panel 600 and it includes a plurality of lamps.

The timing controller 100 supplies a gate voltage and a data voltage to the scan driver 200 and the source driver 300, respectively so as to drive the LCD panel 600. The timing controller 100 supplies a bias voltage control signal BVCS to the switching device 500 such that a bias voltage BV provided from the DC-DC converter 400 is supplied to the LCD panel 600. A liquid crystal (not shown) is transited into a bend alignment state in response to the bias voltage BV provided from the switching device 500.

The timing controller 100 supplies a backlight control voltage B/L_CS to the backlight assembly 800 after a critical time needed to completely transit the liquid crystal into the bend alignment state. The timing controller 100 supplies the bias voltage control signal BVCS to the switching device 500 so as to supply a common voltage Vcom to the LCD panel 600. In order to decide the switching timing of the switching device 500, the LCD may monitor the transition state of the liquid crystal transited into the bend alignment state using an optical sensor. Also, the switching timing of the switching device 500 may be decided by using a capacitance sensor for measuring a capacitance.

The DC-DC converter 400 outputs the bias voltage BV to the switching device 500. The bias voltage BV has a voltage lever lower or higher than a voltage level of the common voltage Vcom, for example, about 5 volts, supplied to the LCD panel 600. That is, a potential difference between the bias voltage BV and the data voltage is greater than a potential difference between the common voltage Vcom and the data voltage, thereby reducing the critical time needed to transit the liquid crystal into the bend alignment state. In this exemplary embodiment, since the DC-DC converter 400, generally, may use a high voltage of about 27 volts used to the scan driver 200, the DC-DC converter 400, generally, uses the high voltage level.

The switching device 500 receives the common voltage Vcom and the bias voltage BV from the DC-DC converter 400 and outputs the common voltage Vcom or the bias voltage BV in response to the bias voltage control signal BVCS provided from the timing controller 100. The common voltage Vcom has a voltage level commonly applied to the LCD panel 600.

The LCD panel 600 includes a plurality of data lines, a plurality of scan lines and a pixel electrode formed at a pixel area defined by the data and scan lines. The pixel electrode is operated in response to the data voltage D1, D2, . . . , Dm provided through a thin film transistor from the source driver 300. The thin film transistor is turned on in response to the gate voltage G1, G2, . . . , Gn provided from the scan driver 200. When the data voltage D1, D2, . . . , Dm is applied to the LCD panel 600, the liquid crystal of the LCD panel 600 receives a high voltage, thereby reducing the critical time needed to allow the liquid crystal disposed at a center portion of the liquid crystal layer to have a tilt angle of about 90 degrees.

The inverter 700 supplies a predetermined driving voltage to the backlight assembly 800 in response to the backlight control signal B/L_CS provided from the timing controller 100. In this exemplary embodiment, the inverter 700 has a module on which various parts, for example, such as a chopper, a transformer, etc., are mounted.

As described above, when initially operating the LCD of the OCB mode, the common voltage Vcom applied to the LCD panel 600 is repeatedly turned on and turned off so as to reduce the critical time needed to transit the liquid crystal into the bend alignment state. Particularly, since the LCD panel 600 receives the bias voltage BV having the voltage level lower or higher than the voltage level of the common voltage Vcom, the critical time needed to transit the liquid crystal into the bend alignment state may be reduced.

Hereinafter, a driving method of the LCD will be described with reference to accompanied drawings.

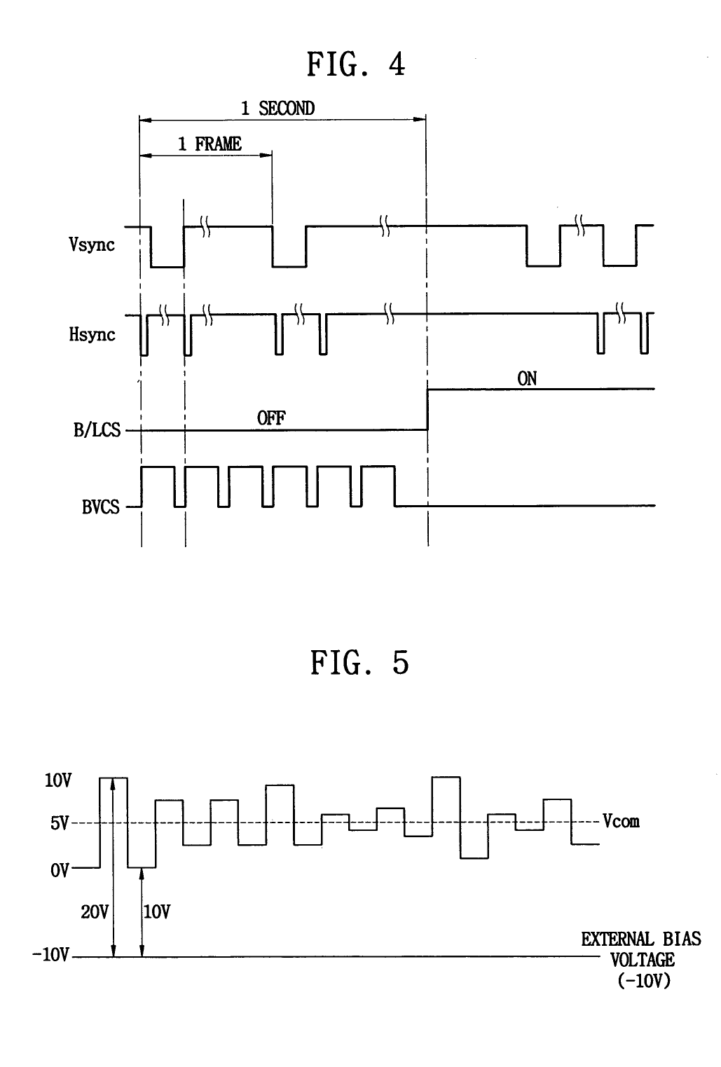

FIG. 4 is a timing diagram of respective signals shown in FIG. 3.

Referring to FIGS. 3 and 4, responsive to a vertical synchronization signal Vsync and a horizontal synchronization signal Hsync externally provided from a host side, the timing controller 100 supplies the backlight control signal B/L_CS to the inverter 700 during a predetermined time, for example, about 1 second, so as to turn off the backlight assembly 800. After the predetermined time, the timing controller 100 supplies the backlight control signal B/L_CS to the inverter 700 so as to turn on the backlight assembly 800.

Also, the timing controller 100 supplies the bias voltage control signal BVCS to the switching device 500, thereby controlling the switching operation of the switching device 500. Particularly, the timing controller 100 supplies the bias voltage control signal B/L_CS to the switching device 500 during the predetermined time such that the switching device 500 periodically selects the bias voltage BV and the common voltage Vcom. After the predetermined time, the timing controller 100 supplies the bias voltage control signal BVCS having an off level to the switching device 500.

That is, the timing controller 100 supplies the backlight control signal B/L_CS having the off level to the inverter so as to turn off the backlight assembly 800 while the liquid crystal is not completely transited into the bend alignment state. Simultaneously, in order to accelerate the transition speed of the liquid crystal transited into the bend alignment state, the timing controller 100 controls the switching device 500 so as to repeatedly supply the common voltage Vcom having the low level and the bias voltage BV having the high level to the LCD panel 600.

When the liquid crystal is completely transited into the bend alignment state, the timing controller 100 supplies the backlight control signal B/L_CS to the inverter 700 to drive the backlight assembly 800 disposed at the rear portion of the LCD panel 800. Thus, the critical time needed to transit the liquid crystal into the bend alignment state is substantially equal to an initial driving time of the LCD and the initial driving time is within about 1 second.

Also, the voltage level of the bias voltage BV is smaller than the voltage level of the common voltage Vcom applied to the LCD panel 600 as shown in FIG. 5.

FIG. 5 is a waveform of a bias voltage according to an exemplary embodiment of the present invention.

Referring to FIG. 5, assuming that the common voltage Vcom applied to the LCD panel 600 is about 5 volts, the bias voltage BV is about −10 volts lower than the common voltage Vcom.

As shown in FIG. 5, in an operation of the LCD of the OCB mode, when the bias voltage BV is lower than that of the common voltage Vcom applied to the common electrode of the LCD panel 600, a voltage difference between the data voltage D1, D2, . . . , Dm applied to the pixel electrode and the bias voltage BV applied to the common electrode is maintained in a range from about 10 volts to about 20 volts. Thus, the critical time needed to transit the liquid crystal into the bend alignment state may be reduced.

In this exemplary embodiment, the range of the voltage difference may be varied since the voltage difference between the pixel electrode and the common electrode is decided in consideration of the critical time that is proportional with the voltage difference.

As described above, when the liquid crystal is completely transited into the bend alignment state, an image may be normally displayed on the LCD panel 600.

However, if a cable for applying a gate signal to the LCD panel 600 is separated from the LCD, a data signal is not normally supplied to the LCD panel 600, thereby breaking down the bend alignment state of the liquid crystal.

In order to prevent the breakdown of the liquid crystal, the LCD panel 600 displays an OSD thereon in response to control of the timing controller 100 while the data signal is not normally supplied to the LCD panel 600. Thus, a user may be aware of a fact that the data signal is not normally supplied to the LCD panel 600. Simultaneously, the timing controller 100 maintains the bend alignment state of the liquid crystal.

Hereinafter, an operation process of the LCD according to the exemplary embodiment of the present invention will be described.

When a power source is turned on, the bias voltage BV having the voltage level higher than that of the common voltage Vcom is supplied to the common electrode, and the liquid crystal is transited into the bend alignment state by means of the voltage difference between the common voltage Vcom and the bias voltage BV.

After the predetermined time, the common voltage Vcom is supplied to the common electrode in lieu of the bias voltage BV, and thus the image is displayed on the LCD panel 600. In order to display the image, the inverter 700 supplies a predetermined driving voltage to the backlight assembly 800, and thus the backlight assembly 800 provides a light to the LCD panel 600 in response to the predetermined driving voltage.

When the data signal is not supplied to the LCD panel 600 while the image is displayed, the timing controller 100 controls the LCD panel 600 such that the OSD is displayed on the LCD panel 600 before the bend alignment state of the liquid crystal is broken down. In cast that a time needed to display the OSD is about 500 microseconds, the transition process of the liquid crystal is simultaneously performed with the displaying process of the OSD, thereby maintaining the bend alignment state of the liquid crystal.

When the data signal is normally supplied to the LCD panel 600, the transition process of the liquid crystal is performed so as to normally display the image externally provided.

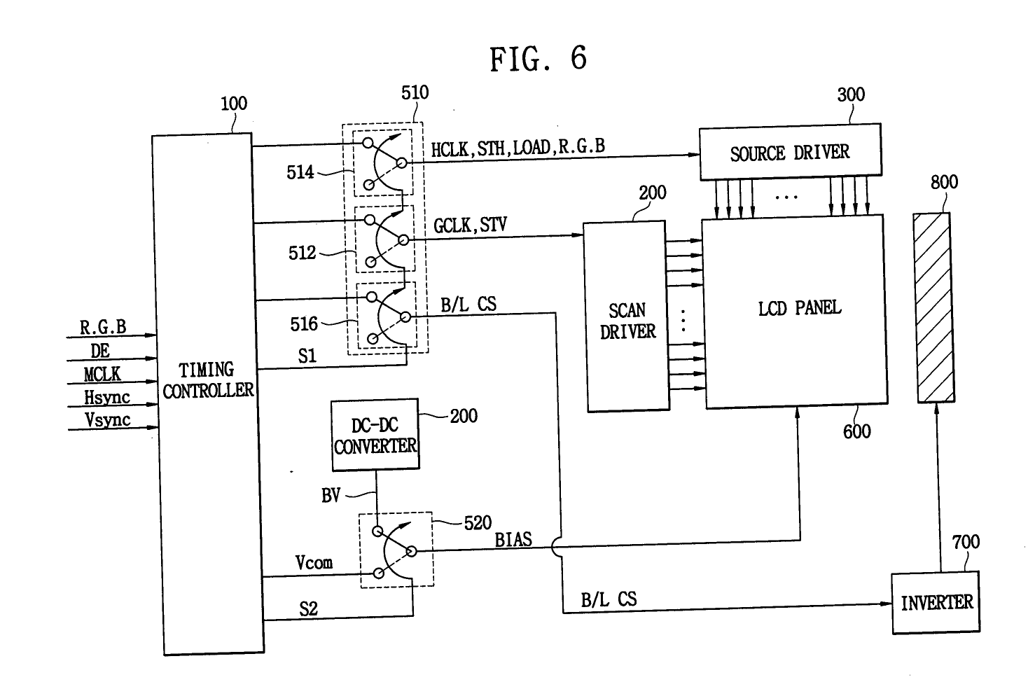

FIG. 6 is a schematic view showing an LCD according to another exemplary embodiment of the present invention. In FIG. 6, the same reference numerals denote the same elements as in FIG. 3, and thus the detailed descriptions of the same elements will be omitted.

Referring to FIG. 6, an LCD according to another exemplary embodiment of the present invention includes a timing controller 100, a scan driver 200, a source driver 300, a DC-DC converter 400, a first switching device 510, a second switching device 520, an LCD panel 600, an inverter 700 and a backlight assembly 800.

The timing controller 100 provides a first switching signal S1 and a second switching signal S2 to the first and second switching devices 510 and 520, respectively.

The first switching device 510 includes a first switch 512, a second switch 514 and a third switch 516. The first switching device 510 provides a gate voltage, a data voltage and a backlight voltage provided from the timing controller 100 to the scan driver 200, source driver 300 and inverter 700, respectively, in response to the first switching signal S1.

Particularly, responsive to the first switching signal S1, the first switch 512 provides a driving signal for the scan driver 200, for example, such as a gate clock signal GCLK, a vertical start signal STV, etc., provided from the timing controller 100 to the scan driver 200.

Responsive to the first switching signal S1, the second switch 514 provides a driving signal for the source driver 300, for example, such as a horizontal clock signal HCLK, a horizontal start signal STH, a load signal, an image signal RGB, etc., provided from the timing controller 100 to the source driver 300.

Also, the third switch 516 provides a backlight control signal B/L_CS provided from the timing controller 100 to the inverter 700 in response to the first switching signal S1.

The second switching device 520 is switched in response to the second switching signal S2 so as to supply a common voltage Vcom and a bias voltage to the LCD panel 600. The common voltage Vcom is provided by the timing controller 100 and the bias voltage BV is provided by the DC-DC converter 200 to a common electrode of the LCD panel 600. When the LCD panel 600 is initially operated, one of the common voltage Vcom and the bias voltage BV, or both of the common electrode and bias voltages Vcom and BV may be supplied to the LCD panel 600. However, after the LCD panel 600 is operated, only one of the common voltage Vcom and the bias voltage BV is applied to the LCD panel 600.

Hereinafter, an operation process of the LCD according to another exemplary embodiment of the present invention will be described.

When a power source is applied to the LCD, the vertical synchronization signal Vsync and the horizontal synchronization signal Hsync are provided to the timing controller 100, thereby operating the LCD. The timing controller 100 applies the driving signal for the scan driver 200 and the driving signal for the source driver 300 to the scan and source drivers 200 and 300, respectively. The driving signal for the scan driver 200 comprises the gate clock signal GCLK and the vertical start signal STV, and the driving signal for the source driver 300 comprises the horizontal clock signal HCLK, horizontal start signal STH, load signal LOAD and image signal RGB.

As a driving signal BIAS applied to the common electrode (not shown) of the LCD panel 600, the common voltage Vcom outputted from the timing controller 100 and the bias voltage BV outputted from the DC-DC converter 200 are repeatedly applied to the LCD panel 600 through the second switching device 520.

The backlight assembly 800 is maintained in an off state because the liquid crystal is not transited into the bend alignment state at the LCD panel 600.

After a first time passes, the timing controller 100 turns off the gate voltage and data voltage applied to the scan and source drivers 200 and 300 through the first switching device 510. The timing controller 100 controls the second switching device 520 so as to supply the bias voltage BV or the common voltage Vcom to the common electrode (not shown) of the LCD panel 600 as the driving signal BIAS. When the driving signal BIAS is applied to the common electrode, a pixel electrode adjacent to a thin film transistor (not shown) of the LCD panel 600 is maintained in a floating state and the common electrode receives a high voltage compared with a ground state. Thus, a high potential difference occurs at the pixel area, thereby transiting the liquid crystal into the bend alignment state. In this exemplary embodiment, the driving signal BIAS applied from the second switching device 520 to the LCD panel 600 alternates a voltage level of about 15 volts or about 0 volts.

After a second time passes, the timing controller 100 supplies the second switching signal S2 to the second switching device 520. The second switching device 520 is switched in response to the second switching signal S2 such that the common voltage Vcom is continuously supplied to the LCD panel 600. Thus, the liquid crystal of the LCD panel 600 is transited into the bend alignment state. The backlight assembly 800 is turned off until the liquid crystal of the LCD panel 600 is completely transited into the bend alignment state.

After a third time passes, the liquid crystal is completely transited into the bend alignment state. The timing controller 100 controls the first switching device 510 and the first switching device 510 is turned on, thereby providing the gate voltage, data voltage and backlight voltage to the scan driver 200, source driver 300 and inverter 700, respectively. The critical time needed to transit the liquid crystal into the bend alignment state is substantially equal to an initial driving time of the LCD and the initial driving time is within about 1 second.

When the liquid crystal is completely transited into the bend alignment state, the LCD panel 600 displays an image using the liquid crystal transited into the bend alignment state.

If the data signal is not supplied to the LCD panel 600 while the image is displayed on the LCD panel 600, the timing controller 100 controls the LCD panel 600 such that the OSD is displayed on the LCD panel 600 before a breakdown of the bend alignment state of the liquid crystal. In cast that a time needed to display the OSD is about 500 microseconds, the transition process of the liquid crystal is simultaneously performed with the displaying process of the OSD so as to maintain the bend alignment state of the liquid crystal.

When the data signal is normally supplied to the LCD panel 600, the transition process of the liquid crystal is performed so as to normally display the externally provided image.

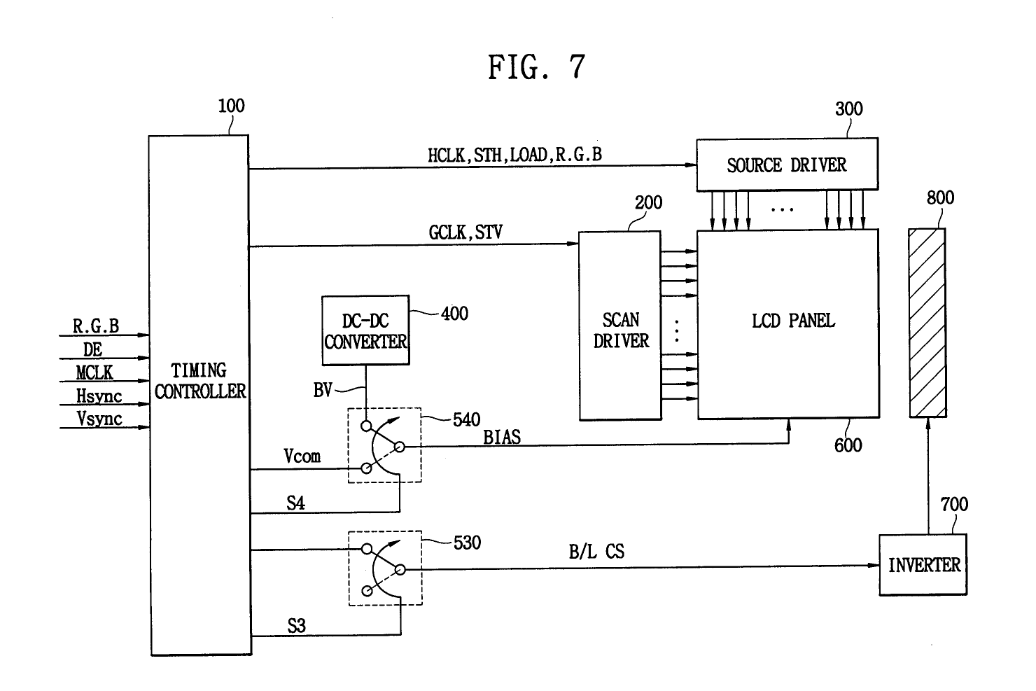

FIG. 7 is a schematic view showing an LCD according to another exemplary embodiment of the present invention. In FIG. 7, the same reference numerals denote the same elements in FIGS. 3 and 6, and thus the detailed descriptions of the same elements will be omitted.

Referring to FIG. 7, an LCD according to another exemplary embodiment of the present invention includes a timing controller 100, a scan driver 200, a source driver 300, a DC-DC converter 400, a first switching device 530, a second switching device 540, an LCD panel 600, an inverter 700 and a backlight assembly 800.

The timing controller 100 provides a first switching signal S3 and a second switching signal S4 to the first and second switching devices 530 and 540, respectively.

The first switching device 530 provides a backlight control signal B/L_CS to the backlight assembly 800 in response to the first switching signal S3 so as to control ON/OFF state of the backlight assembly 800.

Responsive to the second switching signal S4, the second switching device 540 selectively outputs a common voltage Vcom and a bias voltage BV. The common voltage Vcom is provided from the timing controller 100 and the bias voltage BV is provided from the DC-DC converter 400. Further, the second switching device 540 applies the common voltage Vcom and the bias voltage BV to a common electrode (not shown) of the LCD panel 600.

When the LCD panel 600 is initially operated, one of the common voltage Vcom and the bias voltage BV, or both of the common electrode and bias voltages Vcom and BV may be supplied to the LCD panel 600. However, after the LCD panel 600 is operated, only one of the common voltage Vcom and the bias voltage BV may be selectively applied to the LCD panel 600.

Hereinafter, an operation process of the LCD according to another exemplary embodiment of the present invention will be described.

When a power source is applied to the LCD, a vertical synchronization signal Vsync and a horizontal synchronization signal Hsync are provided to the timing controller 100, thereby operating the LCD. The timing controller 100 applies a gate voltage and a data voltage to the scan and source drivers 200 and 300, respectively. As a driving signal BIAS applied to the common electrode (not shown) of the LCD panel 600, the common voltage Vcom output from the timing controller 100 or the bias voltage BV output from the DC-DC converter 200 may be provided to the common electrode of the LCD panel 600.

After a first time passes, the bias voltage BV is applied to the common electrode of the LCD panel 600 through the second switching device 540 as the driving signal BIAS. The common voltage Vcom output from the timing controller 100 and the bias voltage BV output from the DC-DC converter 200 are repeatedly applied to the LCD panel 600 through the second switching device 540. The backlight assembly 800 is maintained in an off state because the liquid crystal is not transited into the bend alignment state.

After a second time passes, the second switching device 540 is switched in response to the second switching signal S2 such that the common voltage Vcom is continuously supplied to the LCD panel 600 as the driving signal BIAS. The data voltage provided from the source driver 300 to the LCD panel 600 includes an alternating current voltage having a voltage level substantially equal to that of the common voltage Vcom. That is, a high potential difference of about 15 volts occurs at a pixel area, thereby transiting the liquid crystal into the bend alignment state. In this exemplary embodiment, the driving signal BIAS output from the second switching device 540 alternates a voltage level of about 15 volts or about 0 volts.

After a third time passes, the timing controller 100 supplies the second switching signal S4 to the second switching device 540. The second switching device 540 is switched in response to the second switching signal S4 such that the common voltage Vcom is continuously supplied to the LCD panel 600. Thus, the liquid crystal of the LCD panel 600 is transited into the bend alignment state. The backlight assembly 800 is turned off until the liquid crystal of the LCD panel 600 is completely transited into the bend alignment state.

After a fourth time passes, the liquid crystal is completely transited into the bend alignment state. The second switching device 540 is switched so as to provide the backlight control signal B/L_CS to the inverter 700 in response to the second switching signal S4 from the timing controller 100. When the liquid crystal is completely transited into the bend alignment state, the LCD panel 600 displays an image using the liquid crystal transited into the bend alignment state. The critical time needed to transit the liquid crystal into the bend alignment state is substantially equal to an initial driving time of the LCD and the initial driving time is within about 1 second.

If the data signal is not supplied to the LCD panel 600 while the image is displayed on the LCD panel 600, the timing controller 100 controls the LCD panel 600 such that the OSD is displayed on the LCD panel 600 before the bend alignment state of the liquid crystal is broken down. In case that a time needed to display the OSD is more than about 500 microseconds, the transition process of the liquid crystal is simultaneously performed with the displaying process of the OSD so as to maintain the bend alignment state of the liquid crystal.

When the data signal is normally supplied to the LCD panel 600, the transition process of the liquid crystal is performed so as to normally display the externally provided image.

As described above, in the LCD operated in the OCB mode, when the data signal is not normally supplied to the LCD panel 600 while the image is displayed on the LCD panel 600, the OSD may be provided to the user through the LCD panel 600 before the bend alignment state of the liquid crystal is broken down.

Also, in case that the critical time needed to display the OSD through the LCD panel 600 exceeds the time for breaking down the bend alignment state of the liquid crystal, the transition process for transiting the liquid crystal into the bend alignment state may be further performed so as to normally display the OSD through the LCD panel 600.

Furthermore, when the data signal is normally supplied to the LCD panel 600, the transition process for transiting the liquid crystal into the bend alignment state is further performed, thereby reducing the critical time needed to transit the liquid crystal into the bend alignment state.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A liquid crystal display comprising:
a liquid crystal display panel having an array substrate on which a scan line and a data line are formed, a color filter substrate on which a common electrode is formed, and a liquid crystal layer interposed between the array and color filter substrates and operated in an OCB mode;
a source driver to supply an image signal to the data line;
a scan driver to supply a scan signal to the scan line; and
a controller, responsive to a power source, to control a bias voltage to be supplied to the common electrode, which has a voltage level higher than that of a common voltage supplied to the common electrode, so as to improve a transition speed of the liquid crystal layer into a bend alignment state, to control the common voltage to be supplied to the common electrode when the liquid crystal layer is transited into the bend alignment state so as to display an image using the image signal, and to control the bias voltage to be supplied to the common electrode when the image signal is not input so as to maintain the bend alignment state of the liquid crystal layer.

2. The liquid crystal display of claim 1, wherein the controller controls an OSD to be displayed on the liquid crystal display panel before the bend alignment state of the liquid crystal layer is broken down when the image signal is not inputted.

3. The liquid crystal display of claim 2, wherein the controller controls the bias voltage to be supplied to the common electrode while the OSD is displayed on the liquid crystal display panel.

4. The liquid crystal display of claim 1, wherein the controller controls the bias voltage to be supplied to the common electrode when the image signal is re-inputted and controls the common voltage to be supplied to the common electrode in lieu of the bias voltage when the liquid crystal layer is transited into the bend alignment state.

5. The liquid crystal display of claim 1, wherein the bias voltage comprises an alternating current voltage.

6. The liquid crystal display of claim 5, wherein the bias voltage comprises a square wave.

7. The liquid crystal display of claim 1, wherein the bias voltage is generated from a power source voltage supplied to the scan driver.

8. The liquid crystal display of claim 1, wherein the controller controls the common voltage and the bias voltage to be alternately supplied to the common electrode in response to the power source.

9. The liquid crystal display of claim 1, further comprising:
a DC-DC converter to generate the bias voltage; and
a switching part to receive the bias voltage and the common voltage and to output the bias voltage or the common voltage to the common electrode in response to control of the controller.

10. The liquid crystal display of claim 1, wherein the bias voltage is supplied to the common electrode for a first time so as to transit the liquid crystal layer into the bend alignment state and the common voltage is supplied to the common electrode after the first time so as to display the image on the liquid crystal display panel.

11. A method of driving a liquid crystal display including a liquid crystal display panel having a liquid crystal operated in an OCB mode, a liquid crystal driving module having a scan driver and a source driver, and a backlight assembly disposed under the liquid crystal display panel, comprising:
responsive to a power source, controlling a bias voltage to be supplied to the liquid crystal display panel so as to improve a transition speed of the liquid crystal into a bend alignment state such that the liquid crystal is operated in the OCB mode;
displaying an image after the liquid crystal is transited into the bend alignment state;
checking whether or not a data signal for the image is inputted;
displaying the image when the data signal is inputted;
checking whether or not a first time passes when the data signal is not inputted;
displaying an OSD representing that the data signal is not inputted when the first time passes;
controlling the liquid crystal to be transited into the bend alignment state while the OSD is displayed;
checking whether or not the data signal for the image is inputted; and
displaying the image after canceling the OSD when the data signal is input.

12. The method of claim 11, wherein the controlling of the liquid crystal further comprises:
cutting off the bias voltage supplied to the liquid crystal display panel and successively supplying a common voltage to the liquid crystal display panel when the first time passes;
supplying a driving voltage to the backlight assembly with the common voltage supplied to the liquid crystal display panel; and
supplying an image signal and a scan signal for the OSD to the liquid crystal display panel.

13. The method of claim 11, wherein the controlling of the liquid crystal comprises:
controlling the image and scan signals for the OSD to be supplied to the liquid crystal display panel;
outputting the bias voltage and common voltage to the liquid crystal display panel; and
supplying the bias voltage to the liquid crystal display panel so as to transit the liquid crystal into the bend alignment state.

14. The method of claim 11, wherein the controlling of the liquid crystal comprises:
controlling the image and scan signals for the OSD to be supplied to the liquid crystal display panel;
controlling output of the bias voltage and common voltage; and
supplying alternately the bias voltage and common voltage to the liquid crystal display panel so as to transit the liquid crystal into the bend alignment state.

15. An apparatus for driving a liquid crystal display including an array substrate having a scan line and a data line, a color filter substrate having a common electrode, and a liquid crystal interposed between the array substrate and color filter substrate and operated in an OCB mode, the driving apparatus comprising;
a source driver to supply an image signal to the data line;
a scan driver to supply a scan signal to the scan line; and
a controller, responsive to a power source, to control a bias voltage to be supplied to the common electrode, which has a voltage level higher than that of a common voltage supplied to the common electrode, so as to improve a transition speed of the liquid crystal layer into a bend alignment state, to control the common voltage to be supplied to the common electrode when the liquid crystal layer is transited into the bend alignment state so as to display an image using the image signal, and to control the bias voltage to be supplied to the common electrode when the image signal is not inputted so as to maintain the bend alignment state of the liquid crystal layer.

16. A liquid crystal display comprising:
a liquid crystal display panel having a first substrate on which a scan line and a data line are formed, a second substrate on which a common electrode is formed, and a liquid crystal layer interposed between the first and second substrates and operated in an OCB mode in response to a bias voltage;
a source driver that supplies an image signal to the data line in response to a first control signal;
a scan driver that supplies a scan signal to the scan line in response to a second control signal;
a DC-DC converter that generates the bias voltage having a first voltage level;
a switching part that receives the bias voltage and a common voltage having a second voltage level lower than the first voltage level and outputs the bias voltage or the common voltage in response to third and fourth control signals; and
a controller that receives a power signal and the image signal, supplies the third control signal to the switching part in response to the power signal so as to apply the bias voltage to the common electrode during a predetermined first time, supplies the first, second and fourth control signals to the source driver, scan driver and switching part, respectively, in response to the image signal so as to supply the common voltage to the common electrode after the predetermined first time, and supplies the third control signal to the switching part when the image signal is not input so as to supply the bias voltage to the common electrode.

17. The liquid crystal display of claim 16, wherein the controller controls an OSD to be displayed on the liquid crystal display panel before the bend alignment state of the liquid crystal layer is broken down when the image signal is not inputted.

18. The liquid crystal display of claim 17, wherein the controller supplies the third control signal to the switching part such that the bias voltage is supplied to the common electrode while the OSD is displayed on the liquid crystal display panel.

19. The liquid crystal display of claim 16, wherein the controller supplies the third control signal to the switching part when the image signal is re-inputted and supplies the fourth control signal to the switching part when the predetermined first time passes.

20. The liquid crystal display of claim 16, wherein the bias voltage comprises an alternating current voltage.
